(19) United States
(12) Patent Application Publication
(10) Pub. No.: US 2025/0326991 A1
(43) Pub. Date: Oct. 23, 2025

(54) CORE-AND-SHELL LAUNDRY COMPOSITION

(71) Applicant: Reckitt Benckiser Vanish B.V., Hoofddorp (NL)

(72) Inventors: Alessandra ANDREOLI, Ellesmere Port, Cheshire (GB); Valeria BALDAN, Mira (IT); Igor DABALA, Mira (IT); Ilaria FARAVELLI, Mira (IT); Marco GASPARATO, Mira (IT); Enrico GIUSTO, Mira (IT); Anna MARCHIANI, Mira (IT); Massimo MOR, Ellesmere Port, Cheshire (GB); Elisa NARDO, Mira (IT); Monica ORDONEZ ERASO, Mira (IT); Lara PIANGENTE, Mira (IT); Simone SCOIZZATO, Mira (IT); Luigina SIMONATO, Mira (IT); Alessandro ZOTTI, Mira (IT)

(21) Appl. No.: 18/857,926

(22) PCT Filed: Mar. 28, 2023
(86) PCT No.: PCT/EP2023/058007

§ 371 Date: Oct. 18, 2024

(30) Foreign Application Priority Data
Apr. 19, 2022 (GB) 2205691.5

(51) Int. Cl. C11D 1/94; C11D 1/10; C11D 3/386; C11D 3/39; C11D 3/43; C11D 17/00

(52) U.S. Cl. CPC C11D 1/94; C11D 1/10; C11D 3/386; C11D 3/3905; C11D 3/43; C11D 17/0095; C11D 2111/12

(57) ABSTRACT

The present invention relates to a core-and-shell laundry composition, wherein the shell comprises: at least one amphoteric surfactant, at least two anionic surfactants, wherein a first anionic surfactant comprises or consists of at least one alkanolamine soap, and at least one polar organic solvent; wherein the shell is in the form of a self-standing gel or a solid at a temperature lower than 50° C. The invention also relates to a method of cleaning a stain on a laundry item and optionally washing the laundry item and to the use of the composition according to the invention for the removal of stains form a garment and/or the removal of malodour form a garment and/or the reduction or elimination of bacteria, viruses and/or fungi from a garment.

The present invention relates to a core-and-shell laundry composition, to a method of cleaning a stain on a laundry item and optionally washing the laundry item and to the use of the core-and-shell laundry composition for the removal of stains from a garment and/or the removal of malodour from a garment and/or the reduction or elimination of bacteria, viruses and/or fungi from a garment.

### BACKGROUND

Consumers associate desirability and wearability of a garment with characteristics such as e.g., absence of stains, good smell, elimination or reduction of bacteria, viruses and/or fungi (i.e., sanitization), and, in the case of white garments, improved whiteness. It is preferred when one or more of these characteristics are achieved using only one product. The removal of stains is normally achieved using bleaching agents, surfactants and/or enzymes. For example, enzymatic stains require enzymes, oil-based stains require enzymes or a combination of surfactants, bleachable stains require a bleaching agent to remove them.

When considering stain removal, some stains contain polyphenols, which are naturally occurring compounds having multiples of phenol units. Examples of polyphenol-containing foods are tea, red wine, curry, and chocolate. These compounds have been used as dyes and for tanning garments; which gives an idea that it is complicated to remove stains of polyphenolic compound soils from a garment.

Curcumin is a yellow active ingredient in turmeric spice; it is a hydrophobic polyphenol derived from the rhizome of turmeric (Curcuma longa). Foods prepared with blends of spices containing turmeric or curry lead to stains that are impossible to remove with common laundry detergents, chlorine bleaches, existing laundry additives or any home remedies. Turmeric is a strong natural colorant and the additional presence of oil, fat, meat and other protein components like egg and milk make this type of stains even more complicated to clean. This means that in cuisines where curry/turmeric plays an important role, people are left with no solution and they have limited choice than to cope with curry/turmeric stains residues on their garments, even after washing.

Clothing is also where germs and bacteria can grow, allowing the formation of malodour. Often laundry detergents and fragrance boosters try to overcome this issue by introducing a substantial amount of scent, for example in the form of microcapsules, that covers the undesired smells. However, once the volatile fragrance molecules leave the fabric, the unpleasant malodour will still be present, or can rebloom, over time or upon ironing.

Regular laundry compositions are useful for cleaning clothes, meaning that grime and dirt are removed. However, for the removal of stains, malodour removal, elimination or reduction of bacteria, viruses and/or fungi (i.e., sanitization), and, in the case of white garments, improved whiteness, additional laundry compositions need to be used.

Normally, people are required to follow long cleaning procedures, involving pre-treatment, vigorous rubbing action, or washings at high temperatures to achieve acceptable stain and malodour removal. For example, washing operations are normally performed at temperatures between 40° C. and 60° C.; and for sanitization purposes as high as 90° C.

Some laundry products providing a consumer benefit, such as improved stain removal, are presented in liquid or powder formats. In liquid formats, it is possible to have surfactants and a bleaching agent such as hydrogen peroxide; however, it is not possible to add enzymes to these formulations. Conversely, in powder formats, it is possible to have a bleaching agent such as sodium percarbonate and enzymes, but the type and amounts of surfactants that can be added to powder formulations is more limited than when considering liquid formats. Notwithstanding the need of a laundry composition capable of providing a consumer benefit such as improved stain removal, malodour removal and/or sanitization, there is a global trend towards concentrated products having a high concentration of actives This translates into lower dosages, smaller products requiring less storage space, and therefore being environmentally friendlier.

Furthermore, some laundry products do not allow for a localised pre-treatment of a garment. For example, if a liquid composition is used it will expand to other areas of the garment which do not need any treatment. If a powder composition is used, this needs to be dissolved with a specific amount of water and then it can be applied to the garment.

Therefore, there is a need of a laundry composition that allows for the combination of different actives in one product to provide a consumer benefit such as stain removal, malodour removal and/or reduction or elimination of bacteria, viruses and/or fungi from a garment. This laundry composition must be suitable to pre-treat specific areas of a garment and also suitable to be used in a washing machine or in pre-soaking.

It is an object of the present invention to provide a core-and-shell laundry composition, which provides a solution for these needs; in particular, the composition may be used to pre-treat specific areas of a garment but also can be used in a washing machine or in pre-soaking.

It is an object of the present invention to provide a method of cleaning a stain on a laundry item.

It is an object of the present invention to provide a use of a composition for the removal of stains, preferably stains comprising, preferably stains comprising a polyphenolic compound such as turmeric and/or curry stains, and/or for the removal of malodour from a garment and/or for the reduction or elimination of bacteria, viruses and/or fungi from a garment.

### SUMMARY OF THE INVENTION

In a first aspect, the present invention relates to a core-and-shell laundry composition, wherein the shell comprises:
at least one amphoteric surfactant,
at least two anionic surfactants, wherein a first anionic surfactant comprises or consists of at least one alkanolamine soap,
at least one polar organic solvent, preferably selected from the group consisting of polar protic solvents; more preferably selected from the group consisting of glycols; most preferably selected from the group consisting of alkylene glycols, dialkylene glycols, and combinations thereof; even most preferably selected from the group consisting of monopropylene glycol, dipropylene glycol, and combinations thereof;
wherein the shell is in the form of a self-standing gel or a solid at a temperature lower than 50° C.

In an embodiment, the shell comprises between 0.01 wt. % and 20 wt. % of the at least one amphoteric surfactant, based on the total weight of the shell, preferably between 0.1 wt. % and 18 wt. %, more preferably between 1 wt. % and 15 wt. %, most preferably between 2.5 wt. % and 12 wt. %.

In another embodiment, the at least one amphoteric surfactant is selected from the group consisting of sulphobetaine, sulphatobetaine, hydroxypropyl sulphobetaine, sulphoimidazolium, sulpho-pyridinium, carboxybetaine, caboxyimidazolium, amidosulphobetaine, amidocarboxybetaine, phosphocholine, phenylphosphinatobetaine, amine oxide, sulphophosphonium, and combinations thereof; preferably selected from the group consisting of sulphobetaine, sulphatobetaine, hydroxypropyl sulphobetaine, carboxybetaine, amidosulphobetaine, amidocarboxybetaine, phenylphosphinatobetaine, amine oxide, and combinations thereof; more preferably selected from the group consisting of carboxybetaine, amidocarboxybetaine, amine oxide, and combinations thereof; most preferably selected from the group consisting of cocamidopropyl betaine, lauryl amidropropyl betaine, lauramine oxide, and combinations thereof.

In an embodiment, the shell comprises between 1 wt. % and 60 wt. % of the at least two anionic surfactants, based on the total weight of the shell, preferably between 5 wt. % and 55 wt. %, more preferably between 10 wt. % and 50 wt. %, most preferably between 20 wt. % and 45 wt. %.

In another embodiment, the at least two anionic surfactants contain at least 40 wt. % of the first anionic surfactant comprising or consisting of at least one alkanolamine soap, based on the total weight of anionic surfactants in the shell of the composition, preferably at least 45 wt. %, more preferably at least 50 wt. %, most preferably between 55 wt. % and 65 wt. %.

In another embodiment, the at least two anionic surfactants comprise a second surfactant selected from the group consisting of alkyl benzene sulphonic acids and their salts, alkoxylated or non-alkoxylated alkyl sulphates and their salts, and combinations thereof; preferably selected from the group consisting of alkoxylated alkyl sulphates and their salts, in which the alkyl chain has between 12 and 18 Carbon atoms; more preferably selected from the group consisting of ethoxylated alkyl sulphates and their salts, in which the alkyl chain has between 12 and 18 Carbon atoms; most preferably selected from the group consisting of ethoxylated alkyl sulphates and their salts, in which the alkyl chain has between 12 and 18 Carbon atoms and the alkyl sulphate has less than 5 ethylene oxide units, preferably less than 3, more preferably less than 2.5.

In an embodiment, the shell comprises between 1 wt. % and 50 wt. % of the at least one organic solvent, based on the total weight of the shell, preferably between 5 wt. % and 45 wt. %, more preferably between 10 wt. % and 40 wt. %, most preferably between 15 wt. % and 35 wt. %.

In another embodiment, the shell further comprises at least one non-ionic surfactant, preferably selected from the group consisting of alkoxylated alcohols, alkoxylated alkyl phenols, alkyl amide monoisopropanol amines, and combinations thereof; preferably selected from the group consisting of ethoxylated alcohols, alkyl amide monoisopropanol amines, and combinations thereof; more preferably selected from the group consisting of ethoxylated alcohols represented by the formula R¹(OCH₂CH₂)ₙOH; wherein R¹ is an alkyl moiety having between 8 and 20 carbon atoms, preferably between 10 and 18 carbon atoms, and n has an average value of less than 10, preferably less than 8, more preferably between 4 and 7, alkyl amide monoisopropanol amines in which the alkyl chain has between 8 and 18 carbon atoms, and combinations thereof; wherein preferably the shell comprises less than 40 wt. % of the at least one non-ionic surfactant, based on the total weight of the shell, preferably less than 35 wt. %, more preferably less than 30 wt. %, most preferably between 1 wt. % and 27 wt. %.

In a preferred embodiment, the core comprises at least one bleaching agent, at least one bleach activator, and at least one enzyme.

In an embodiment, the at least one bleaching agent comprises at least one source of active oxygen selected from the group comprising an inorganic peroxide, an organic peracid, hydrogen peroxide, and combinations thereof; preferably selected from the group comprising sodium percarbonate, ε-phthalimido-peroxy-hexanoic acid (PAP), peracetic acid, potassium peroxymonosulfate (KMPS), and combinations thereof; most preferably wherein said at least one bleaching agent comprises or consist of sodium percarbonate.

In another embodiment, the at least one bleach activator is selected from the group consisting of tetraacetylethylendiamine (TAED), acetylated triazine derivatives, acetylated glycoluriles, acylimides, acetylated phenolsulfonates, acetylated phenol carbonic acids, sodium nonanoyloxybenzenesulfonate (NOBS), 4-decanoyloxybenzoic Acid (DOBA), carbonic acid anhydrides, acetylated sugar derivatives, N-acetylated lactams, and combinations thereof; preferably said at least one bleach activator comprises or consists of tetra acetylethylenediamine (TAED).

In an embodiment, the at least one enzyme is selected from the group consisting of proteases, amylases, mannanases, lipases, and combinations thereof.

In an embodiment, the core further comprises at least one oxygen transfer agent selected from the group consisting of 3-methyl-1,2-benzisothiazol-1,1-dioxide, 1,2,3-Benzoxathiazine, 2,2-dioxide, and combinations thereof, preferably wherein the at least one oxygen transfer agent comprises or consists of 3-methyl-1,2-benzisothiazol-1,1-dioxide.

In a preferred embodiment, the core is in the form of a solid, preferably wherein the core is in the form of a powder.

In another preferred embodiment, the core comprises:
between 20 wt. % and 60 wt. % of said at least one bleaching agent, based on the total weight of the core, preferably between 25 wt. % and 59 wt. %, more preferably between 30 wt. % and 58 wt. %; and/or
between 0.001 wt. % and 5 wt. % of said at least one enzyme, based on the total weight of the core, preferably between 0.01 wt. % and 4 wt. %, more preferably between 0.05 wt. % and 2.5 wt. %; and/or
between 0.1 wt. % and 10 wt. % of said at least one oxygen transfer agent, based on the total weight of the core, preferably between 0.15 wt. % and 5 wt. %, more preferably between 0.20 wt. % and 2 wt. %; and/or
between 0.1 wt. % and 25 wt. % of said at least one bleach activator, based on the total weight of the core, preferably between 0.25 wt. % and 20 wt. %, more preferably between 0.5 wt. % and 15 wt. %, most preferably between 1 wt. % and 10 wt. %.

In another embodiment, the laundry composition is comprised of at least 40 wt. % of the shell, based on the total weight of the composition, preferably at least 45 wt. %, more preferably between 50 wt. % and 70 wt. %, most preferably between 55 wt. % and 65 wt. %.

In a preferred embodiment, the shell is transparent or translucent.

In another preferred embodiment, the laundry composition is a laundry detergent or a laundry additive composition.

In a preferred embodiment, the laundry composition is a mono-dose composition having a weight of between 10 g and 50 g, preferably between 15 g and 40 g, more preferably between 20 g and 30 g, even more preferably between 22.5 g and 28.5 g.

In a second aspect, the invention relates to a method of cleaning a stain on a laundry item and optionally washing the laundry item, comprising:
contacting and rubbing the stain directly with composition according to the first aspect of the invention before the laundry item is washed, and/or
adding the composition according to the first aspect of the invention directly into the drum of a washing machine and performing the washing operation, or
adding the composition according to any of the first aspect of the invention to a bucket with water and soaking for a predetermined length of time.

In a third aspect the invention relates to a use of the composition according to the first aspect of the invention for the removal of stains form a garment and/or the removal of malodour form a garment and/or the reduction or elimination of bacteria, viruses and/or fungi from a garment.

### Definitions

The following definitions are used in the present application.

“Laundry composition” as used in the present application means: composition which is used in a laundry wash process. The process can be carried out by hand or in a laundry washing machine.

“Laundry detergent composition” as used in the present application means: composition used primarily for the cleaning of garments and whose main action is the removal of grime and dirt, comprising a builder and not having lipases.

“Laundry additive composition” as used in the present application means: composition which is used for providing a specific consumer benefit, such as: removal of stains, elimination of malodour, improvement of whiteness and/or disinfection of garments. This means that the mean action of a laundry additive is not the removal or grime and dirt. Furthermore, a laundry additive is commonly used as a pre-treatment, in soaking conditions or together with a laundry detergent composition.

“Core-and-shell laundry composition” as used in the present patent application means: laundry composition having an inner core and an outer shell made of different components, wherein the shell surrounds and is in direct contact with the core.

“Mono-dose” as used in the present application means: a laundry composition provided in a specific amount, generally an amount suitable to treat one load of laundry. For example, the amount of the laundry composition when provided as a mono-dose may be between 10 g and 50 g, preferably between 15 g and 40 g, more preferably between 20 g and 30 g, even more preferably between 22.5 g and 28.5 g.

“Self-standing gel” as used in the present application means: gel that does not flow in steady state, for example, at a temperature of less than 55° C. and 1 atm pressure. Gel is to be understood as being a three-dimensional network which behaves like a solid and that exhibits no flow in the steady state. A gel has a yield stress, meaning that this material does not flow until a certain shear-stress threshold is overcome.

“Protease” as used in the present application means: class of enzymes that catalyse the breakdown of proteins into smaller polypeptides or single amino acids.

“Amylase” as used in the present application means: class of enzymes that catalyse the hydrolysis of starch into sugars such as glucose and maltose.

“Mannanase” as used in the present application means: class of enzymes that catalyse the hydrolysis of mannose derivatives.

“Mannose” as used in the present application means: sugar monomer of the aldohexose series of carbohydrates.

“Lipase” as used in the present application means: class of enzymes that catalyse the hydrolysis of fats or lipids.

### DETAILED DESCRIPTION OF THE INVENTION

In a first aspect, the present invention relates to a core-and-shell laundry composition, wherein the shell comprises:
At least one amphoteric surfactant,
At least two anionic surfactants, wherein a first anionic surfactant comprises or consists of at least one alkanolamine soap,
At least one polar organic solvent, preferably selected from the group consisting of polar protic solvents; more preferably selected from the group consisting of glycols; most preferably selected from the group consisting of alkylene glycols, dialkylene glycols, and combinations thereof; even most preferably selected from the group consisting of monopropylene glycol, dipropylene glycol, and combinations thereof;
   wherein the shell is in the form of a self-standing gel or a solid at a temperature lower than 50° C.

The combination of materials in the shell leads to a self-standing gel or a solid at a temperature lower than 50° C.; however, when the combination of materials in the shell is heated to temperatures higher than 55° C., for example between 55° C. and 75° C., it melts. This allows for the processability of the melt, using for example, melt-and-pour technologies to shape the shell.

Furthermore, the core-and-shell composition allows for the delivery of ingredients in the core which are protected by the shell. As the shell is a self-standing gel or a solid at a temperature lower than 50° C., when provided as a mono-dose, wrapping of the core-and-shell composition may not be needed.

### Shell

The shell may comprise between 0.01 wt. % and 20 wt. % of the at least one amphoteric surfactant, based on the total weight of the shell, preferably between 0.1 wt. % and 18 wt. %, more preferably between 1 wt. % and 15 wt. %, most preferably between 2.5 wt. % and 12 wt. %. For example, the shell may comprise more than 2 wt. % of the at least one amphoteric surfactant, based on the total weight of the shell, or more than 3 wt. %, or more than 4 wt. %, and less than 11 wt. %, or less than 10 wt. %.

Amphoteric surfactants are able to form a cation or anion according to ambient conditions, such as pH changes. Generally, the cationic part is an amine salt or quaternary ammonium hydrophilic group, whilst the anionic moiety is a carboxylate, sulphonate, or phosphate hydrophilic group. For example, the amino-acid-type amphoteric surfactants contain both amino and carboxy group or the intramolecular-ammonium-salt type amphoteric surfactants having a carboxyl group and a quaternary ammonium group.

In the present invention, the at least one amphoteric surfactant may be selected from the group consisting of sulphobetaine, sulphatobetaine, hydroxypropyl sulphobetaine, sulphoimidazolium, sulpho-pyridinium, carboxybetaine, caboxyimidazolium, amidosulphobetaine, amidocarboxybetaine, phosphocholine, phenylphosphinatobetaine, amine oxide, sulphophosphonium, and combinations thereof; preferably selected from the group consisting of sulphobetaine, sulphatobetaine, hydroxypropyl sulphobetaine, carboxybetaine, amidosulphobetaine, amidocarboxybetaine, phenylphosphinatobetaine, amine oxide, and combinations thereof; more preferably selected from the group consisting of carboxybetaine, amidocarboxybetaine, amine oxide, and combinations thereof; most preferably selected from the group consisting of cocamidopropyl betaine, lauryl amidopropyl betaine, lauramine oxide, and combinations thereof.

The shell may comprise between 1 wt. % and 60 wt. % of the at least two anionic surfactants, based on the total weight of the shell, preferably between 5 wt. % and 55 wt. %, more preferably between 10 wt. % and 50 wt. %, most preferably between 20 wt. % and 45 wt. %. For example, the shell may comprise more than 22 wt. % of the at least two anionic surfactants, based on the total weight of the shell, or more than 24 wt. % and less than 40 wt. %, or less than 38 wt. % or less than 36 wt. %.

The shell has a first anionic surfactant comprising or consisting of at least one alkanolamine soap. Alkanolamines react with fatty acids to produce neutral alkanolamine soaps, which are commonly used in cosmetic and pharmaceutical applications. The at least one alkanolamine soap consists or comprises monoisopropanolamine stearate, which is the result of the neutralization of stearic acid with monoisopropanol amine, this compound is also known as a monoisopropanolamine soap.

The at least two anionics surfactants may contain at least at least 40 wt. % of the first anionic surfactant comprising or consisting of at least one alkanolamine soap, based on the total weight of anionic surfactants in the shell of the composition, preferably at least 45 wt. %, more preferably at least 50 wt. %, most preferably between 55 wt. % and 65 wt. %.

It will be understood that the at least two anionic surfactants comprise a second surfactant, which may be selected from the group consisting of alkyl benzene sulphonic acids and their salts, alkoxylated or non-alkoxylated alkyl sulphates and their salts, and combinations thereof; preferably selected from the group consisting of alkoxylated alkyl sulphates and their salts, in which the alkyl chain has between 12 and 18 Carbon atoms; more preferably selected from the group consisting of ethoxylated alkyl sulphates and their salts, in which the alkyl chain has between 12 and 18 Carbon atoms; most preferably selected from the group consisting of ethoxylated alkyl sulphates and their salts, in which the alkyl chain has between 12 and 18 Carbon atoms and the alkyl sulphate has less than 5 ethylene oxide units, preferably less than 3, more preferably less than 2.5.

The shell may further comprise at least one non-ionic surfactant, preferably selected from the group consisting of alkoxylated alcohols, alkoxylated alkyl phenols, alkyl amide monoisopropanol amines, and combinations thereof; preferably selected from the group consisting of ethoxylated alcohols, alkyl amide monoisopropanol amines, and combinations thereof; more preferably selected from the group consisting of ethoxylated alcohols represented by the formula R¹(OCH₂CH₂)ₙOH; wherein R¹ is an alkyl moiety having between 8 and 20 carbon atoms, preferably between 10 and 18 carbon atoms, and n has an average value of less than 10, preferably less than 8, more preferably between 4 and 7; alkyl amide monoisopropanol amines in which the alkyl chain has between 8 and 18 carbon atoms, and combinations thereof. The shell may comprise less than 40 wt. % of the at least one non-ionic surfactant, based on the total weight of the shell, preferably less than 35 wt. %, more preferably less than 30 wt. %, most preferably between 1 wt. % and 27 wt. %.

In a preferred embodiment, the shell has less than 30 wt. % water, based on the total weight of the shell, preferably less than 25 wt. %, more preferably less than 20 wt. %, most preferably between 5 wt. % and 18 wt. %.

The shell in the core-and-shell composition comprises at least one polar organic solvent, preferably selected from the group consisting of polar protic solvents, more preferably selected from the group consisting of glycols, most preferably selected from the group consisting of alkylene glycols or dialkylene glycols, even most preferably selected from the group consisting of monopropylene glycol, dipropylene glycol, and combinations thereof. The shell may comprise between 1 wt. % and 50 wt. % of the at least one organic solvent, based on the total weight of the shell, preferably between 5 wt. % and 45 wt. %, more preferably between 10 wt. % and 40 wt. %, most preferably between 15 wt. % and 35 wt. %.

In a preferred embodiment, the weight ratio of dipropylene glycol to monopropylene glycol in the shell, i.e., dipropylene glycol: monopropylene glycol, is at least 0.25:1, preferably at least 0.5:1, more preferably between 0.5:1 and 10:1, most preferably between 1:1 and 8:1.

The shell may comprise other ingredients such as dyes, sequestrants, and polymers.

In a preferred embodiment, the core-and-shell laundry composition has a shell which comprises:
between 2.5 wt. % and 20 wt. % of at least one amphoteric surfactant, based on the total weight of the shell, preferably selected from the group consisting of cocamidopropyl betaine, lauryl amidopropyl betaine, lauramine oxide, and combinations thereof
between 20 wt. % and 60 wt. % of at least two anionic surfactants, based on the total weight of the shell,
   the shell comprising at least 40 wt. % of a first anionic surfactant comprising or consisting of at least one alkanolamine soap, based on the total weight of anionic surfactants in the shell of the composition,
   the second surfactant selected from the group consisting of ethoxylated alkyl sulphates, in which the alkyl chain has between 12 and 18 Carbon atoms and the alkyl sulphate has less than 5 ethylene oxide units, preferably less than 3, more preferably less than 2.5
between 15 wt. % and 50 wt. % of at least one polar organic solvent, preferably selected from the group consisting of monopropylene glycol, dipropylene glycol, and combinations thereof;
Wherein the shell is in the form of a self-standing gel or a solid at a temperature lower than 50° C.

When the core-and-shell composition has a high concentration of surfactants, it is possible to rub the composition against a stained garment to remove the stains. The present inventors have observed that the combination of ingredients in the shell are particularly useful in the removal of greasy stains. Examples of greasy stains are butter fat and make up.

The shell may have any suitable form such as a sphere, an oval, a cylinder, a cube, a polyhedron, etc.

The shell may further comprise fragrances and/or dyes.

### The Core

The aim of the invention is to provide a core-and-shell laundry composition in which different ingredients can be provided in the core and in the shell. The core may then comprise at least one bleaching agent, at least one bleach activator, and at least one enzyme. When the core has these compounds, the composition is then effective at removing not only greasy stains but also enzymatic stains, such as starchy stains, e.g., potato starch.

The at least one bleaching agent may comprise at least one source of active oxygen selected from the group comprising an inorganic peroxide, an organic peracid, hydrogen peroxide, and combinations thereof; preferably selected from the group comprising sodium percarbonate, ε-phthalimido-peroxy-hexanoic acid (PAP), peracetic acid, potassium peroxymonosulfate (KMPS), and combinations thereof; most preferably wherein said at least one bleaching agent comprises or consist of sodium percarbonate.

The at least one bleach activator may be selected from the group consisting of tetraacetylethylendiamine (TAED), acetylated triazine derivatives, acetylated glycoluriles, acylimides, acetylated phenolsulfonates, acetylated phenol carbonic acids, sodium nonanoyloxybenzenesulfonate (NOBS), 4-decanoyloxybenzoic Acid (DOBA), carbonic acid anhydrides, acetylated sugar derivatives, N-acetylated lactams, and combinations thereof; preferably said at least one bleach activator comprises or consists of tetra acetylethylenediamine (TAED).

The composition may comprise between 0.1 wt. % and 20 wt. % of said at least one bleach activator, based on the total weight of the core, preferably between 0.25 wt. % and 15 wt. %, more preferably between 0.5 wt. % and 10 wt. %, most preferably between 1 wt. % and 5 wt. %.

The at least one enzyme may be selected from the group consisting of proteases, amylases, mannanases, lipases, and combinations thereof. For example, the composition may comprise between 0.001 wt. % and 5 wt. % of said at least one enzyme, based on the total weight of the core, preferably between 0.01 wt. % and 4 wt. %, more preferably between 0.05 wt. % and 2.5 wt. %.

The core may further comprise at least one oxygen transfer agent selected from the group consisting of 3-methyl-1,2-benzisothiazol-1,1-dioxide, 1,2,3-Benzoxathiazine, 2,2-dioxide, and combinations thereof, preferably wherein the at least one oxygen transfer agent comprises or consists of 3-methyl-1,2-benzisothiazol-1,1-dioxide.

These oxygen transfer agents react in the washing liquor to produce oxaziridines, which are responsible for the improved stain removal.

The compositions comprising an oxygen transfer agent, as previously discussed, allow for the removal of stains and malodour, especially the removal of stains comprising a polyphenolic compound, even at temperatures lower than those usually used in automatic laundry washing. It is believed that by adding the oxygen transfer agent to the core, which already comprises a bleaching agent, a bleach activator, and enzymes, the activation energy needed to bleach a stain is reduced. This means that removal of stains and malodour from a fabric can be achieved at a temperature of, for example, 30° C., or even lower, and faster than when a composition not comprising an oxygen transfer agent is used.

In addition, the present inventors have observed a synergistic effect between the oxygen transfer agent, the bleaching agent, the bleach activator, and the enzymes. This is evidenced by the combined removal of stains and malodour and optionally the whiteness improvement as shown in the examples that follow.

An effect that is obtained with compositions comprising an oxygen transfer agent in the core, in particular in garments made of polyester, is improvement of whites or whitening. As previously discussed, the oxygen transfer agents produce oxaziridines, which have a hydrophobic nature and can interact with polyethylene terephthalate in polyesters textiles. This interaction allows for a better whitening of the textiles.

The core may be in any form that is not incompatible with the shell. For example, it may be a liquid, a dispersion, or a solid, as long as it does not detrimentally react with the shell. The core is preferably in the form of a solid, more preferably in the form of a powder.

In a preferred embodiment, the core-and-shell laundry composition comprises a core, which comprises
between 20 wt. % and 60 wt. % of said at least one bleaching agent, based on the total weight of the core, preferably between 25 wt. % and 59 wt. %, more preferably between 30 wt. % and 58 wt. %; and/or
between 0.001 wt. % and 5 wt. % of said at least one enzyme, based on the total weight of the core, preferably between 0.01 wt. % and 4 wt. %, more preferably between 0.05 wt. % and 2.5 wt. %; and/or
between 0.1 wt. % and 10 wt. % of said at least one oxygen transfer agent, based on the total weight of the core, preferably between 0.15 wt. % and 5 wt. %, more preferably between 0.20 wt. % and 2 wt. %; and/or
between 0.1 wt. % and 25 wt. % of said at least one bleach activator, based on the total weight of the core, preferably between 0.25 wt. % and 20 wt. %, more preferably between 0.5 wt. % and 15 wt. %, most preferably between 1 wt. % and 10 wt. %.

In another preferred embodiment the weight ratio of the said at least one bleaching agent to the said at least one oxygen transfer agent is less than 650:1, preferably less than 500:1, more preferably between 10:1 and 400:1, most preferably between 100:1 and 300:1. The present inventors have observed that these weight ratios provide the best results in terms of stain removal, malodour removal, and/or reduction or elimination of bacteria, viruses and/or fungi from a garment. This also allows for the use of smaller amounts of compositions in the shell having between 30 wt. % and 59 wt. %, for example between 40 wt. % and 58 wt. %, or between 45 wt. % or 57 wt. %, of a bleaching agent in a laundry washing or fabric treatment operation.

Preferably the pH at 20° C. of a dilution of 1:100 of the components of the core is between 9 and 12, more preferably between 9.5 and 11.5, even more preferably between 10 and 11.

The core may further comprise a rheology modifier agent, a fragrance, a phase stabilizer, a dye, a softening agent, a chelating agent, an anti-bacterial agent, a transition metal compound, an anti-foaming agent, a preservative, one or more further surfactants, one or more fillers, a dye-transfer inhibitor, an optical brightener, or combinations thereof.

Suitable fillers include bicarbonates and carbonates of metals, such as alkali metals and alkaline earth metals. Examples include sodium carbonate, sodium bicarbonate, calcium carbonate, calcium bicarbonate, magnesium carbonate, magnesium bicarbonate and sesqui-carbonates of sodium, calcium and/or magnesium. Other examples include metal carboxy glycine and metal glycine carbonate. Chlorides, such as sodium chloride; citrates; and sulphates, such as sodium sulphate, calcium sulphate and magnesium sulphate, may also be employed. Preferably the composition comprises at least one filler selected from the group comprising alkyl carbonate, alkyl sulphate and combinations thereof; more preferably selected from the group comprising sodium carbonate, sodium sulphate and combinations thereof.

When a filler is present, the core may comprise between 0.1 wt. % and 80 wt. % of said at least one filler, based on the total weight of the core, preferably between 10 wt. % and 75 wt. %, more preferably between 20 wt. % and 70 wt. %.

The core may comprise an optical brightener, preferably selected from the group comprising stilbene, benzidine, benzothiazole, benzimidazole, benzoxazole, coumarin, pyrazoline, naphtalimide, naphtoxazole, distyryl-biphenyl, benzonitrile, benzopyrazole, including their derivatives and substituted compounds, and combinations thereof. Suitable optical brighteners include 4,4′-bis(2-sulphostyryl) diphenyl, 7-Diethylamino-4-methylcoumarin, benzoxazole, 2,2′-(1,2-ethenediyl) bis[5-methyl] including their substituted compounds, 4,4′-bis (triazine-2ylamino) stilbene-2,2′-disulphonic acid, mono (azol-2-yl) stilbene and bis (azol-2yl) stilbene; styryl derivatives of benzene and biphenyl, such as 1,4-bis (styryl) benzene, 4,4′-bis (styryl) benzene, 4,4′-bis-(styryl) biphenyl, 4,4′-bis (sulphostryryl) biphenyl sodium salt; pyrazolines such as 1, 3-diphenyl-2-pyrazoline; bis (benzene-2-yl) derivatives, bis (benzoxazol-2-yl) derivatives and bis (benzimidazol-2-yl) derivatives; 2-(benzofuran-2-yl) benzimidazole; coumarins such as 4-methyl-7-hydroxy-coumarin or 4-methyl-7- diethylaminocoumarin; carbostyrils; naphthalimides; dibenzothiophene5,5-dioxide; pyrene; or pyridotriazole derivatives and combinations thereof.

When an optical brightener is present, the core may comprise between 0.001 wt. % and 1 wt. % of at least one optical brightener, based on the total weight of the shell, preferably between 0.01 wt. % and 0.5 wt. %, more preferably between 0.05 wt. % and 0.25 wt. %.

The shell may further comprise a dye-transfer inhibitor. Preferred dye-transfer inhibitors (sometimes called dye anti-redisposition agents or soil suspending agents) include polyvinylalcohol, fatty amides, sodium carboxylmethyl cellulose, hydroxypropyl methyl cellulose, polyvinylpyrollidone, polyvinylimidazole, polyvinyloxazolidone, polyamine N-oxide polymers and copolymers or N-vinylpyrollidone and N-vinylimidazole.

When a dye-transfer inhibitor is present, the shell may comprise between 0.001 wt. % and 1.5 wt. % of at least one dye transfer inhibitor, based on the total weight of the shell, preferably between 0.01 wt. % and 1.0 wt. %, more preferably between 0.05 wt. % and 0.75 wt. %.

In the core-and-shell laundry composition the shell may account for at least 40% of the total weight of the composition, preferably at least 45%, more preferably between 50% and 70%, most preferably between 55% and 65%.

In a preferred embodiment, the shell is transparent or translucent.

The core-and-shell laundry composition may be a laundry detergent or a laundry additive composition.

The core-and-shell laundry composition may be a mono-dose composition having a weight of between 10 g and 50 g, preferably between 15 g and 40 g, more preferably between 20 g and 30 g, even more preferably between 22.5 g and 28.5 g.

It will be understood that the shell in the core-and-shell laundry composition preferably has a thickness with allow for a good mechanical resistance of the composition and acceptable dissolution time of the shell. For example, the shell may have a thickness of more than 1 mm, and preferably less than 100 mm; for example, between 2 mm and 50 mm, more preferably between 3 mm and 25 mm, even more preferably between 3.5 mm and 10 mm.

The shell may be made by mixing all components at a temperature higher than for example 55° C. to obtain a melted composition. The composition is them poured into a mould; then a plastic insert is introduced inside the mould and the melted composition with the insert is left to cool down at room temperature, i.e., between 18° C. and 25° C. It takes between about 5 to 10 minutes for the melted composition to cool down, and hence to solidify; after it solidifies a solid composition with a cavity is obtained. The cavity in the solid composition is filled with a powder and the cavity containing the powder is then closed by slowly pouring additional melted product to the top to completely cover the powder and wait until complete solidification. The monodose can be then removed from the mould.

In a second aspect, the invention relates to a method of cleaning a stain on a laundry item and optionally washing the laundry item, comprising:
contacting and rubbing the stain directly with composition according to the first aspect of the invention before the laundry item is washed, and/or
adding the composition according to the first aspect of the invention directly into the drum of a washing machine and performing the washing operation, or
adding the composition according to the first aspect of the invention to a bucket with water and soaking for a predetermined length of time.

In an embodiment of the second aspect the method of cleaning a stain on a laundry item and washing the laundry item comprises:
contacting and rubbing the stain directly with composition according to the first aspect of the invention before the laundry item is washed, and
adding that composition directly into the drum of a washing machine and performing the washing operation.

The laundry item may be made of a wide range of materials, such as cotton, linen, and synthetic materials.

Consumers normally use temperatures of at least 40° C. to wash stained laundry items; reducing the washing temperature is environmentally friendlier but is often associated with a poorer performance. The method of cleaning a stain on a laundry item and optionally washing the laundry item may be performed at a temperature lower than 40° C., preferably lower than 35° C., more preferably between 15° C. and 30° C.

A laundry item may be washed by adding certain amount, e.g., about 25 g, of the composition according to the first aspect of the invention to a washing machine and washing the laundry item following a regular cycle of said machine.

In a preferred embodiment, a laundry item is washed with a mixture comprising a laundry detergent composition not according to the invention and between 10 g and 50 g or a composition according to the first aspect of the invention, preferably between 15 g and 40 g, more preferably between 20 g and 30 g, even more preferably between 22.5 g and 28.5 g.

In a preferred embodiment the amount of laundry detergent composition according to the first aspect of the invention that can be added to a washing machine, considering the amount of water in the main wash, is between 0.67 g/L and 4 g/L, preferably between 1 g/L and 3 g/L, more preferably between 1.4 g/L and 2 g/L, even more preferably between 1.5 g/L and 1.9 g/L.

A laundry item may be also washed by first rubbing the composition according to the first aspect of the invention against the stained part of the laundry item, for an amount of time of between 10 seconds and 300 seconds, preferably between 20 seconds and 180 seconds, more preferably between 25 seconds and 120 seconds, followed by washing in a regular laundry washing machine. It will be understood that the washing operation in the washing machine may be performed using a detergent system comprising only a laundry detergent not according to the invention or a combination of a laundry detergent not according to the invention and the composition according to the first aspect of the invention.

In a third aspect, the invention relates to a use of the laundry composition according to the first aspect of the invention for the removal of stains form a garment and/or the removal of malodour form a garment and/or the reduction or elimination of bacteria, viruses and/or fungi from a garment.

The foregoing aspects may be freely combined with any of the foregoing aspects disclosed herein.

The invention will be further described, by way of example, with the reference to the following non-limiting embodiments.

### EXAMPLES

### Formulations

Table 1 shows a powder and a liquid formulation, which are not in the form of a core- and-shell composition.

TABLE 1
Comparative formulations - liquid and powder

Formulation

| Ingredient | A (Liquid) | B (Powder) |
|---|---|---|
| Sodium hydroxide | 0.44 | |
| Anionic surfactant * | 3.00 | |
| Non-ionic surfactant * | 10.75 | |
| HEDP | 0.20 | |
| Hydrogen peroxide | 10.50 | |
| BHT | 0.03 | |
| Fragrance | 0.15 | |
| Dye | 0.0008 | |
| PVP | 0.09 | |
| Thickener | 4.00 | |
| Antifoam agent | 0.02 | |
| Water | q.s. | |
| Sodium Carbonate | | 13.00 |
| Sodium Sulphate | | 38.45 |
| Sodium Percarbonate | | 40.00 |
| TAED | | 4.00 |
| Non-ionic surfactant ¹ | | 0.25 |
| Anionic surfactant ¹ | | 2.00 |
| Protease | | 0.29 |
| Mannanase | | 0.15 |
| Lipase | | 0.20 |
| Amylase | | 0.064 |
| Cellulase | | 0.10 |
| Fragrance | | 0.30 |
| PVP-VI | | 0.20 |
| Additional ingredients | | q.s. |

In Table 1:
Non-ionic surfactant *: ethoxylated alcohols with an ethoxylation degree between 2 and 8.
Anionic surfactant *: Alkyl benzene sulphonic acid.
PVP: the homopolymer of 1-vinyl-2-pyrrolidone with a molecular weight of 40 000 g/mol.
Non-ionic surfactant 1: ethoxylated alcohol with a hydrophobic chain having between 12 and 16 carbon atoms. Ethoxylation degree between 4 and 5.
PVP-VI: copolymer of 1-vinyl-2-pyrrolidone and 1-vinylimidazole with a molecular weight of about 70 000 g/mol
Enzyme concentrations are of the enzymes as received, i.e., an enzyme preparation.
Additional ingredients: fillers.

Table 2 shows formulations according to the invention, in which the formulations are in the form of a core-and-shell laundry composition. In all formulations shown in table 2, the shell accounts for about 60% of the total weight of the formulation and the core for about 40%. The total weight of each formulation is about 25 g.

In all formulations shown in Table 2, the core is translucent or transparent and the core is a powder. This means that it is possible to see through the shell that the formulation has an internal phase.

TABLE 2
Formulations according to the invention in the
form of a core-and-shell laundry product.

| | Formulation | | |
|---|---|---|---|
| Ingredient | 1 | 2 | 3 |
| Shell | wt. % based on total weight of the shell | | |
| Lauramine oxide | 6-11 | 6-11 | 6-11 |
| Alkanolamine soap | 15-25 | 15-25 | 15-25 |
| Anionic surfactant | 10-16 | 10-16 | 10-16 |
| Non-ionic surfactant | −24-29 | −24-29 | −24-29 |
| Organic solvent | 10-25 | 10-25 | 20-35 |
| Water | 8-18 | 8-18 | 8-18 |
| Additional ingredients | 1-5 | 1-5 | 1-5 |
| Powder | wt. % based on total weight of the powder | | |
| Sodium Sulphate | 14.24 | 23.90 | 23.90 |
| Sodium Percarbonate | 45.00 | 45.00 | 55.00 |
| TAED | 4.32 | 2.76 | 5.52 |
| Oxygen transfer agent | 1.80 | 0.60 | |
| Anionic surfactant ¹ | 1.50 | | |
| Protease | 6.00 | 3.00 | 3.00 |
| Mannanase | 4.00 | | 1.00 |
| Lipase | 6.00 | | 1.00 |
| Amylase | 2.00 | 1.00 | 0.64 |
| PVP-VI | 0 | 1.50 | 1.50 |
| Additional ingredients ¹ | q.s. | q.s. | q.s. |

Alkanolamine soap: monoisopropanolamine soap.
Anionic surfactant: sodium salt of an ethoxylated sulphate in which the alkyl chain has between 12 and 16 carbon atoms and it has less than 2.5 ethylene oxide units.
Non-ionic surfactant: ethoxylated alcohols represented by the formula R¹(OCH₂CH₂)ₙOH; wherein R¹ is an alkyl moiety having 10 carbon atoms and n has an average value of 5, alkyl amide monoisopropanol amines in which the alkyl chain has between 8 and 18 carbon atoms, and combinations thereof
Organic solvent: monopropylene glycol, dipropylene glycol or a mixture thereof.
Additional ingredients: polymers, sequestrants.
Enzyme concentrations are of the enzymes as received, i.e., an enzyme preparation.
   For the Protease preparation, it contained about 12 wt. % of the protease, based on the total weight of the protease preparation; this means that for a formulation having a powder comprising 6 wt. % of protease preparation, it had about 0.72 wt. % of protease as such, based on the total weight of the powder.
   For the Mannanase preparation, it contained about 4 wt. % of the protease as such, based on the total weight of the mannanase preparation.
   For the Lipase preparation, it contained about 7 wt. % of the lipase as such, based on the total weight of the lipase preparation.
   For the Amylase preparation, it contained about 7 wt. % of the amylase as such, based on the total weight of the amylase preparation.
Additional ingredients 1: fillers and antifoam agent.
Oxygen transfer agent =3-methyl-1,2-benzisothiazol-1, 1-dioxide
Anionic surfactant 1: sodium lauryl sulphate.
PVP-VI: copolymer of 1-vinyl-2-pyrrolidone and 1-vinylimidazole with a molecular weight of about 70 000 g/mol.

### Performance Tests

### Removal of Stains in a Washing Machine

Technical stains supported on cotton were washed in a laundry washing machine in a washing liquor containing one of the detergent systems shown in Table X at 30° C. The washing with only the commercial detergent was carried out at 40° C.

TABLE 3
Detergent systems

| Detergent | |
|---|---|
| system | Components |
| Det* | 35 mL Commercial detergent |
| Da* | 35 mL Commercial detergent + 100 mL Formulation A |
| Db* | 35 mL Commercial detergent + 60 g Formulation B |
| D1 | 35 mL Commercial detergent + Formulation 1 |
| D2 | 35 mL Commercial detergent + Formulation 2 |
| D3 | 35 mL Commercial detergent + Formulation 3 |

The commercial detergent in Table 3 is Ariel liquid as sold in the UK.

### Washing Test Conditions

Each sample was washed in a Bosch WAE24256II laundry washing machine at a temperature of 30° C. (or 40° C. for detergent system Det*) using a cotton cycle (duration of the main wash about 44 minutes), water hardness of 28° F.

Stain removal was determined using a Datacolor 650 spectrophotometer and by measuring the Y-value of the technical stains after washing. A higher Y-value represents a better stain removal.

The results of these tests are shown in Table 4.

TABLE 4
Removal of different technical stains supported on cotton

| | | | Y - values | | | | |
|---|---|---|---|---|---|---|---|
| | | | Detergent system | | | | |
| | Stain Code | Stain Name | Det * | Da* | Db* | D1 | D3 |
| Bleachable | C-S-08 | Grass | 57.85 | 62.42 | 77.76 | 79.29 | 66.80 |
| stains | C-S-15 | Blueberry juice | 43.47 | 47.79 | 59.14 | 64.06 | 51.86 |
| | C-S-67 | Mustard | | 78.08 | 82.07 | 84.70 | |
| | KC-H026 | Red wine | | 52.05 | 49.91 | 61.05 | |
| | KC-H109 | Espresso coffee | | 51.76 | 57.87 | 63.06 | |
| | W-10J | Tea | 62.66 | 67.98 | 67.07 | 65.92 | 66.74 |
| | W-10SG | Spaghetti sauce | 55.81 | 56.12 | 60.64 | 61.11 | 58.48 |
| | | with meat | | | | | |
| | W-10U | Curry | 81.54 | 83.73 | 81.47 | 83.34 | 84.79 |
| | WE5ECWKC | Coffee | 60.98 | 65.64 | | | 67.59 |
| | WE5FSMWKC | French squeeze | 67.59 | 72.48 | | | 79.72 |
| | | mustard | | | | | |
| | WE5GMWKC | Grass/Mud | 44.95 | 44.67 | | | 45.41 |
| | WE5LTWKC | Tea | 44.35 | 49.64 | | | 49.52 |
| | WE5RWWKC | Red wine | 56.35 | 61.64 | | | 62.85 |
| | WE5SGWKC | Grass scrubbed | 38.15 | 51.56 | | | 54.93 |
| | WE5TPWKC | Tomato puree | 67.59 | 70.61 | | | 79.10 |
| | Average | | 56.77 | 61.08 | 66.99 | 70.31 | 63.98 |
| Enzymatic | C-S-27 | Potato | 71.86 | 68.83 | 66.43 | 73.59 | 70.15 |
| stains | | starch/colorant | | | | | |
| | C-S-406 | Balsamic | 46.93 | 53.12 | 57.33 | 59.94 | 49.61 |
| | | Dressing | | | | | |
| | W-10Z | Chocolate | 61.74 | 63.96 | 69.82 | 70.68 | 65.92 |
| | WE5DASBKC | Sheep blood | 57.45 | 65.37 | | | 75.02 |
| | Average | | 59.49 | 62.82 | 64.53 | 68.07 | 65.17 |
| Greasy | W-10D | Skin grease/ | 49.84 | 51.75 | 56.59 | 61.56 | 51.09 |
| stains | | pigment | | | | | |
| | W-10MU | Make up | 56.83 | 61.08 | 72.53 | 73.24 | 59.69 |
| | W-10RM | Soot mineral | 32.34 | 31.32 | 30.28 | 29.16 | 31.76 |
| | | oil, IEC | | | | | |
| | W-10V | Soy sauce | 85.56 | 86.55 | 84.59 | 87.04 | 87.28 |
| | C-S-10 | Butter fat/ | | 75.48 | 73.91 | 75.57 | |
| | | colorant | | | | | |
| | WE5BBWKC | Cooked beef | 79.57 | 76.67 | | | 78.69 |
| | | fat | | | | | |

| | | | | | |
|---|---|---|---|---|---|
| Average | 60.83 | 63.81 | 63.58 | 65.31 | 61.70 |

The results in table 4 demonstrate that compositions according to the invention (present in detergent systems D1 and D3) provide a better stain removal than the commercial detergent alone. It should be noted that the temperature used for washing with the detergent system with only the commercial detergent was higher that the temperature used with the other detergent systems. Furthermore, detergent system D3 provides a better stain removal than the detergent system containing the comparative formulations. It should be noted that the amounts of the comparative formulations used in the detergent systems is higher than the amounts of formulations 1 and 3 used in the detergent systems (100 ml of formulation A, 60 g of formulation B, versus 25 g of formulation 1 or 2).

These results clearly demonstrate that when an oxygen transfer agent is added to the core of the core-and-shell formulation, the stain removal performance is greatly improved.

Although at first glance it might seem that the detergent system comprising formulation 3 performs worse than the detergent system comprising formulation B, this is not the case. In detergent system Db* 60 g of formulation B are used, whilst in detergent system 3 only 25 g of formulation 3 are used. This indicates that similar amounts of formulation 3 (according to the invention) and formulation B will provide similar or better stain removal performance; even lower amounts of formulation 3 provide better stain removal of enzymatic stains than higher amounts of formulations A and B.

### Stain Removal Performance With Different Amounts of Oxygen Transfer Agent

Following the same washing tests conditions as previously described, the stain removal performance of D1, D2 were compared with the stain removal performance of Da* and Db *. The results of these tests are shown in table 5, in which “0” means no difference regarding stain removal performance, compared to Da* or Db*, “+” means improved stain removal performance, and “−” means inferior stain removal performance.

TABLE 5
Stain removal performance of detergent systems having
different amounts of oxygen transfer agent

| | | | Y - values | | | |
|---|---|---|---|---|---|---|
| | | | Detergent system | | | |
| | Stain Code | Stain Name | D2 vs. Da* | D1 vs. Da* | D2 vs. Db* | D1 vs. Db* |
| Bleachable | C-S-08 | Grass | + | + | − | + |
| stains | C-S-15 | Blueberry juice | + | + | − | + |
| | C-S-67 | Mustard | 0 | + | − | + |
| | KC-H026 | Red wine | + | + | 0 | + |
| | KC-H109 | Espresso coffee | + | + | − | + |
| | W-10J | Tea | − | 0 | − | 0 |
| | W-10SG | Spaghetti sauce | 0 | + | − | + |
| | | with meat | | | | |
| | W-10U | Curry | + | + | − | + |
| Enzymatic | C-S-27 | Potato | + | + | + | + |
| stains | | starch/colorant | | | | |
| | C-S-406 | Balsamic | 0 | 0 | + | + |
| | | Dressing | | | | |
| | W-10Z | Chocolate | 0 | + | − | 0 |
| Greasy | W-10D | Skin grease/ | 0 | + | − | + |
| stains | | pigment | | | | |
| | W-10MU | Make up | + | + | + | + |
| | W-10RM | Soot mineral | 0 | 0 | + | 0 |
| | | oil, IEC | | | | |
| | W-10V | Soy sauce | + | + | 0 | + |
| | C-S-10 | Butter fat/ | + | 0 | + | + |
| | | colorant | | | | |

Table 5 clearly demonstrates that higher amounts of oxygen transfer agent lead to a better stain removal performance.

### Stability of Core-and-Shell Formulations

Formulations as shown in table 2 were subjected to stability tests. These tests consisted in storing the formulations at temperatures between 40° C. and 50° C. In addition, at 40° C. some tests were carried out at a relative humidity of 75%. The formulations were observed after 1 week and after 6 weeks. All three formulations maintained their shapes and the performance of these was not detrimentally affected.

The compositions according to the invention provides:
Removal of stains, especially stains containing a polyphenolic compound, such as turmeric and curry greasy stains;
Malodour removal; and
Preferably, also whiteness improvement in a garment.

Hence one or more objects of the present invention are achieved by the present which is further elucidated in the appended claims.

1. A core-and-shell laundry composition, wherein the shell comprises:
at least one amphoteric surfactant,
at least two anionic surfactants, wherein a first anionic surfactant comprises or consists of at least one alkanolamine soap,
at least one polar organic solvent, preferably selected from the group consisting of polar protic solvents; more preferably selected from the group consisting of glycols; most preferably selected from the group consisting of alkylene glycols, dialkylene glycols, and combinations thereof; even most preferably selected from the group consisting of monopropylene glycol, dipropylene glycol, and combinations thereof;
wherein the shell is in the form of a self-standing gel or a solid at a temperature lower than 50° C.

2. The laundry composition according to claim 1, wherein the shell comprises between 0.01 wt. % and 20 wt. % of the at least one amphoteric surfactant, based on the total weight of the shell, preferably between 0.1 wt. % and 18 wt. %, more preferably between 1 wt. % and 15 wt. %, most preferably between 2.5 wt. % and 12 wt. %.

3. The laundry composition according to claim 1, wherein the at least one amphoteric surfactant is selected from the group consisting of sulphobetaine, sulphatobetaine, hydroxypropyl sulphobetaine, sulphoimidazolium, sulpho-pyridinium, carboxybetaine, caboxyimidazolium, amidosulphobetaine, amidocarboxybetaine, phosphocholine, phenylphosphinatobetaine, amine oxide, sulphophosphonium, and combinations thereof; preferably selected from the group consisting of sulphobetaine, sulphatobetaine, hydroxypropyl sulphobetaine, carboxybetaine, amidosulphobetaine, amidocarboxybetaine, phenylphosphinatobetaine, amine oxide, and combinations thereof; more preferably selected from the group consisting of carboxybetaine, amidocarboxybetaine, amine oxide, and combinations thereof; most preferably selected from the group consisting of cocamidopropyl betaine, lauryl amidropropyl betaine, lauramine oxide, and combinations thereof.

4. The laundry composition according to claim 1, wherein the shell comprises between 1 wt. % and 60 wt. % of the at least two anionic surfactants, based on the total weight of the shell, preferably between 5 wt. % and 55 wt. %, more preferably between 10 wt. % and 50 wt. %, most preferably between 20 wt. % and 45 wt. %.

5. The laundry composition according to claim 1, wherein the at least two anionic surfactants contain at least 40 wt. % of the first anionic surfactant comprising or consisting of at least one alkanolamine soap, based on the total weight of anionic surfactants in the shell of the composition, preferably at least 45 wt. %, more preferably at least 50 wt. %, most preferably between 55 wt. % and 65 wt. %.

6. The laundry composition according to claim 1, wherein the at least two anionic surfactants comprise a second surfactant selected from the group consisting of alkyl benzene sulphonic acids and their salts, alkoxylated or non-alkoxylated alkyl sulphates and their salts, and combinations thereof; preferably selected from the group consisting of alkoxylated alkyl sulphates and their salts, in which the alkyl chain has between 12 and 18 Carbon atoms; more preferably selected from the group consisting of ethoxylated alkyl sulphates and their salts, in which the alkyl chain has between 12 and 18 Carbon atoms; most preferably selected from the group consisting of ethoxylated alkyl sulphates and their salts, in which the alkyl chain has between 12 and 18 Carbon atoms and the alkyl sulphate has less than 5 ethylene oxide units, preferably less than 3, more preferably less than 2.5.

7. The laundry composition according to claim 1, wherein the shell comprises between 1 wt. % and 50 wt. % of the at least one organic solvent, based on the total weight of the shell, preferably between 5 wt. % and 45 wt. %, more preferably between 10 wt. % and 40 wt. %, most preferably between 15 wt. % and 35 wt. %.

8. The laundry composition according to claim 1, wherein the shell further comprises at least one non-ionic surfactant, preferably selected from the group consisting of alkoxylated alcohols, alkoxylated alkyl phenols, alkyl amide monoisopropanol amines, and combinations thereof; preferably selected from the group consisting of ethoxylated alcohols, alkyl amide monoisopropanol amines, and combinations thereof; more preferably selected from the group consisting of ethoxylated alcohols represented by the formula R¹(OCH₂CH₂)ₙOH; wherein R¹ is an alkyl moiety having between 8 and 20 carbontoms, preferably between 10 and 18 carbon atoms, and n has an average value of less than 10, preferably less than 8, more preferably between 4 and 7, alkyl amide monoisopropanol amines in which the alkyl chain has between 8 and 18 carbon atoms, and combinations thereof; wherein preferably the shell comprises less than 40 wt. % of the at least one non-ionic surfactant, based on the total weight of the shell, preferably less than 35 wt. %, more preferably less than 30 wt. %, most preferably between 1 wt. % and 27 wt. %.

9. The laundry composition according to claim 1, wherein the core comprises at least one bleaching agent, at least one bleach activator, and at least one enzyme.

10. The laundry composition according to claim 9, wherein the at least one bleaching agent comprises at least one source of active oxygen selected from the group comprising an inorganic peroxide, an organic peracid, hydrogen peroxide, and combinations thereof; preferably selected from the group comprising sodium percarbonate, ε-phthalimido-peroxy-hexanoic acid (PAP), peracetic acid, potassium peroxymonosulfate (KMPS), and combinations thereof; most preferably wherein said at least one bleaching agent comprises or consist of sodium percarbonate.

11. The laundry composition according to claim 9, wherein the at least one bleach activator is selected from the group consisting of tetraacetylethylendiamine (TAED), acetylated triazine derivatives, acetylated glycoluriles, acylimides, acetylated phenolsulfonates, acetylated phenol carbonic acids, sodium nonanoyloxybenzenesulfonate (NOBS), 4-decanoyloxybenzoic Acid (DOBA), carbonic acid anhydrides, acetylated sugar derivatives, N-acetylated lactams, and combinations thereof; preferably said at least one bleach activator comprises or consists of tetra acetylethylenediamine (TAED).

12. The laundry composition according to claim 9, wherein the at least one enzyme is selected from the group consisting of proteases, amylases, mannanases, lipases, and combinations thereof.

13. The laundry composition according to claim 9, wherein the core further comprises at least one oxygen transfer agent selected from the group consisting of 3-methyl-1,2-benzisothiazol-1,1-dioxide, 1,2,3-Benzoxathiazine, 2,2-dioxide, and combinations thereof, preferably wherein the at least one oxygen transfer agent comprises or consists of 3-methyl-1,2-benzisothiazol-1,1-dioxide.

14. The laundry composition according to claim 9, wherein the core is in the form of a solid, preferably wherein the core is in the form of a powder.

15. The laundry composition according to claim 9, wherein the core comprises:
between 20 wt. % and 60 wt. % of said at least one bleaching agent, based on the total weight of the core, preferably between 25 wt. % and 59 wt. %, more preferably between 30 wt. % and 58 wt. %; and/or
between 0.001 wt. % and 5 wt. % of said at least one enzyme, based on the total weight of the core, preferably between 0.01 wt. % and 4 wt. %, more preferably between 0.05 wt. % and 2.5 wt. %; and/or
between 0.1 wt. % and 10 wt. % of said at least one oxygen transfer agent, based on the total weight of the core, preferably between 0.15 wt. % and 5 wt. %, more preferably between 0.20 wt. % and 2 wt. %; and/or
between 0.1 wt. % and 25 wt. % of said at least one bleach activator, based on the total weight of the core, preferably between 0.25 wt. % and 20 wt. %, more preferably between 0.5 wt. % and 15 wt. %, most preferably between 1 wt. % and 10 wt. %.

16. The laundry composition according to claim 1, wherein the composition is comprised of at least 40 wt. % of the shell, based on the total weight of the composition, preferably at least 45 wt. %, more preferably between 50 wt. % and 70 wt. %, most preferably between 55 wt. % and 65 wt. %.

17. The laundry composition according to claim 1, wherein the shell is transparent or translucent.

18. The laundry composition according to claim 1, wherein the composition is a laundry detergent or a laundry additive composition.

19. The laundry composition according to claim 1, wherein the composition is a mono-dose composition having a weight of between 10 g and 50 g, preferably between 15 g and 40 g, more preferably between 20 g and 30 g, even more preferably between 22.5 g and 28.5 g.

20. A method of cleaning a stain on a laundry item and optionally washing the laundry item, comprising:
contacting and rubbing the stain directly with composition according to claim 1 before the laundry item is washed, and/or
adding the composition according to claim 1 directly into the drum of a washing machine and performing the washing operation, or
adding the composition according to claim 1 to a bucket with water and soaking for a predetermined length of time.

21. (canceled)
